(19) United States
(12) Patent Application Publication
(10) Pub. No.: US 2009/0274019 A1
(43) Pub. Date: Nov. 5, 2009

(54) Optical Scanning Apparatus for Appliances for Recording or Reproducing Information Using an Optical Recording Medium

(76) Inventors: Uwe Bartels, Schwenningen (DE); Michael Bammert, Hardt (DE); Ralf Bausch, Loefflingen (DE); Tsuneo Suzuki, Moenchweiler (DE); Chien Chung Fu, Shenzen City (CN); Frank Aschenbrenner, Duerrheim (DE)

Correspondence Address: Thomson Licensing LLC, P.O. Box 5312, Two Independence Way, PRINCETON, NJ, 08543-5312, US

(21) Appl. No.: 11/794,706

(22) PCT Filed: Dec. 13, 2005
(86) PCT No.: PCT/EP05/56711

§ 371 Date: Jul. 3, 2007

(30) Foreign Application Priority Data
Jan. 6, 2005 (DE) 10 2005 000 909.3

(51) Int. Cl. G11B 7/00

(52) U.S. Cl. 369/44.22; G9B/7

(57) ABSTRACT

The invention provides an optical scanning apparatus for appliances for recording or reproducing information using an optical recording medium, said scanning apparatus automatically matching itself to the curvature of a curved recording medium or of a recording medium with axial runout without there being different wire diameters for the resilient support of the lens holder (LH) or other additional damping means or an additional control loop for this purpose. This object is achieved by virtue of an arrangement comprising coils and magnets being provided which has an asymmetrical magnetic field distribution which is provided for matching the orientation of a lens (L) in the optical scanning device to a curved recording medium or to any axial runout in the recording medium. The asymmetrical magnetic field distribution is achieved with magnets arranged offset laterally or with magnets (MS) which are bevelled on one side or with a focusing coil which is asymmetrically shaped or is arranged asymmetrically with respect to the magnets. The individual embodiments for achieving an asymmetrical magnetic field distribution can be combined with one another.

The invention relates to an optical scanning apparatus for appliances for recording or reproducing information using an optical recording medium, which apparatus automatically matches itself to the curvature of a curved recording medium or of a recording medium with axial runout.

Examples of recording and/or reproduction appliances for optical recording media are CD or DVD players, which use the optical scanning apparatus, known as a “pick-up”, to read information from a disc-like recording medium, such as a CD (compact disc) or a digital versatile disc—DVD for short—or to write said information to the recording medium.

The optical scanning apparatus usually comprises a coarse drive mechanism and a fine drive mechanism, with the coarse drive mechanism being a carriage, guided on a guide rod, with a toothed rack which is driven using an electric motor. The carriage carries the fine drive mechanism, which has a lens holder with a lens, a focusing coil and at least one tracking coil. The lens holder is connected to the coarse drive mechanism by means of a resilient support, which comprises relatively thin wires for supplying current to the coils, for example, and there are magnets which use the magnetic field from the coils to deflect the lens from a position of rest. The optical scanning apparatus is guided in a radial direction and at a constant distance to focus a scanning beam on the information track of the recording medium for the purpose of recording or reproducing information. To ensure optimum recording or reading of the recording medium despite the recording medium usually being curved toward the edge or exhibiting axial runout, a further control loop may be provided which is used to orient the laser beam scanning the recording medium perpendicularly onto the recording medium.

For the purpose of automatic matching to the disc curvature or axial runout, it is already known practice to coat wires which are arranged relatively close to the centre of the disc with an elastic compound whose damping is different from that of the wires which are arranged closer to the edge of the disc, and to use wires whose length or arrangement is different or wires with a different diameter. The known apparatuses have the drawback that they either require additional components or that tolerances need to be observed which already exceed manufacturing-related discrepancies in the wire diameter, so that only wires manufactured with increased accuracy can be used as the resilient support.

It is therefore an object of the invention to design an optical scanning apparatus such that automatic matching of the orientation of the lens to the disc curvature or to the axial runout is achieved appropriately without additional involvement in terms of components and for a wide tolerance range for the wire diameter. This object is achieved by means of features specified in the independent claim by virtue of an arrangement comprising coils and magnets being provided which has an asymmetrical magnetic field distribution which is provided in appropriate fashion for matching the orientation of a lens in the optical scanning device to a curved recording medium or to any axial runout in the recording medium. Advantageous exemplary embodiments are specified in dependent claims.

The inventive measure of designing the optical scanning device's arrangement comprising coils and magnets to be asymmetrical generates a tilting moment or a torque, when the lens is deflected from a position of rest which is required for focusing onto a curved recording medium or on account of axial runout, which (tilting moment or torque) is used in appropriate fashion to match the orientation of the lens of the optical scanning device to a curved recording medium or to any axial runout in the recording medium. The angle through which the lens is tilted away from a perpendicular provided for a flat recording medium is dependent on the level or degree of the curvature or on the axial runout by which the recording medium differs from a flat recording medium, which means that a more greatly curved recording medium or a greater axial runout results in comparatively greater inclination of the lens in order to orient the optical axis of the lens or of the scanning device onto the recording medium as perpendicularly as possible. The extent or the value by which the angle changes as a function of the deflection is determined by the asymmetry of the optical scanning device's arrangement comprising coils and magnets, but surprisingly it has been found that the asymmetry provided for changes in the focusing direction influences the properties of the optical scanning device as regards tracking only insignificantly or not at all. It was not possible to assume such independence between the means of tracking and the means for focusing in the case of asymmetrical arrangement of coils and magnets on account of the joint use of the magnets for tracking and for focusing.

The asymmetrical magnetic field distribution is achieved through asymmetrical association of the coils and magnets with one another or through asymmetrical design of the magnets or of the focusing coil. The variants in the design of any asymmetry, whether this be the asymmetrical arrangement of the magnets and of the focusing coil relative to one another or the asymmetrical design of the magnets or of the focusing coil, can be used individually and in combination with one another.

One advantage of the invention is that neither additional elements nor elements which need to be manufactured with increased accuracy are required, but rather the asymmetrical arrangement of coil and magnet relative to one another or the asymmetrical design of the coil and magnet are sufficient to achieve matching of the lens to the disc curvature or to the axial runout. Further advantages are that the asymmetry and hence also the manner in which the inclination of the lens is changed as a function of the deflection can be varied within a wide range by combining the proposed embodiments, and secondly that tolerances in the components of the optical scanning device, such as the wire diameter of the resilient support, influence the intended matching of the orientation of the lens to the recording medium only insignificantly or not at all. This is achieved, in particular, by virtue of the angle through which the direction of the lens changes as a function of the deflection being largely independent of the value of the damping or of the rigidness of the resilient support. This can be attributed to the fact that the current which is required to focus and hence to deflect the lens with the magnetic field from a focusing coil when there is axial runout or a curved recording medium is provided by a control loop and is set such that any opposed force emanating from the resilient support is overcome. A corresponding force emanating from the resilient support is also required to incline or rotate the lens through an angle. The current or the magnetic field from the focusing control loop is used both to deflect and to match the orientation of the lens in the optical scanning device to a curved recording medium or to any axial runout in the recording medium, which means that a magnetic field corresponding to the damping or rigidness of the resilient support is provided both for deflecting and for inclining or rotating the lens and, as a result, independence from the absolute value of the damping or of the rigidness of the resilient support is achieved. A higher or lower level of damping or rigidness of the resilient support requires a correspondingly greater or lesser magnetic field both for deflecting and for inclining or rotating the lens, which means that changes in the wire diameter or in the strength of the wires used for the resilient support influence the matching of the orientation of the lens to the disc curvature or to the axial runout only insignificantly or not at all. An optical scanning apparatus is provided which automatically matches itself to the disc curvature or to the axial runout in the recording medium without additional involvement in terms of components and for a wide tolerance range for the diameter of the wires of the resilient support.

The invention is described in more detail below using exemplary embodiments which are illustrated in drawings, in which:

FIG. 1 shows a basic outline of a recording medium with axial runout,

FIG. 2 shows a basic outline of a curved recording medium,

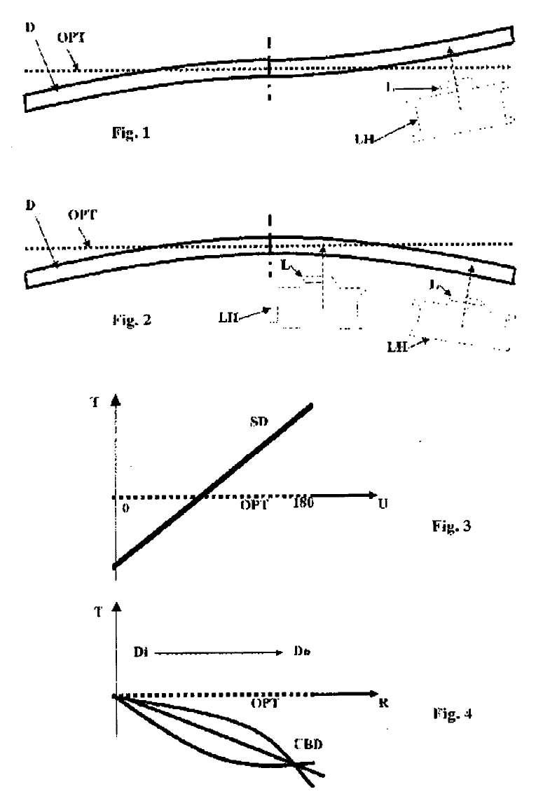

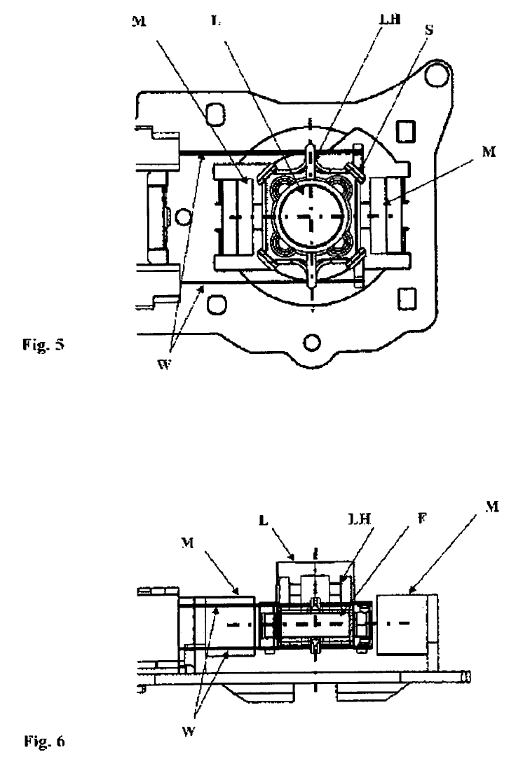

FIG. 3 shows a graph of the angle of inclination of the lens as a function of the angle of rotation for a recording medium with axial runout,

FIG. 4 shows a graph of the angle of inclination of the lens as a function of the radial position of the scanning apparatus for a recording medium with curvature,

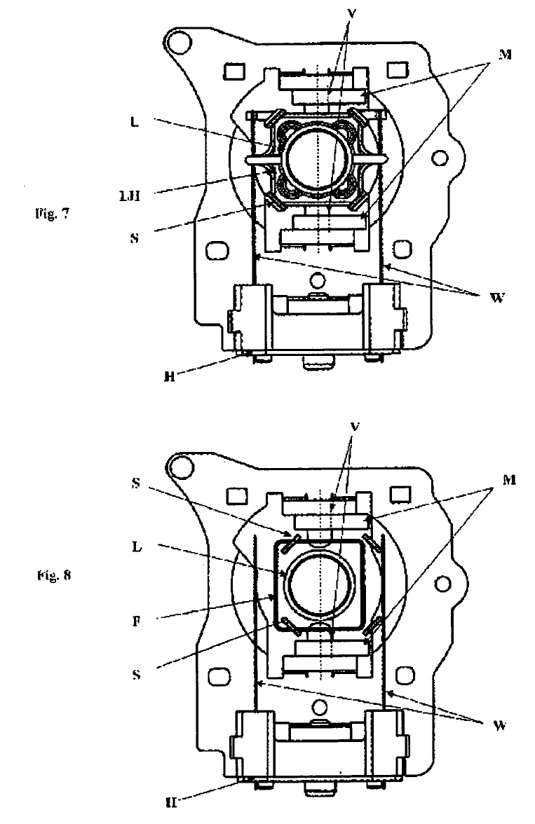

FIG. 5 shows a basic outline of a plan view of a known optical scanning apparatus of symmetrical design,

FIG. 6 shows a basic outline of a side view of a known optical scanning apparatus of symmetrical design,

FIG. 7 shows a basic outline of a plan view of an optical scanning apparatus with asymmetrically arranged magnets,

FIG. 8 shows a basic outline of a plan view of an optical scanning apparatus with asymmetrically arranged magnets and tracking coils,

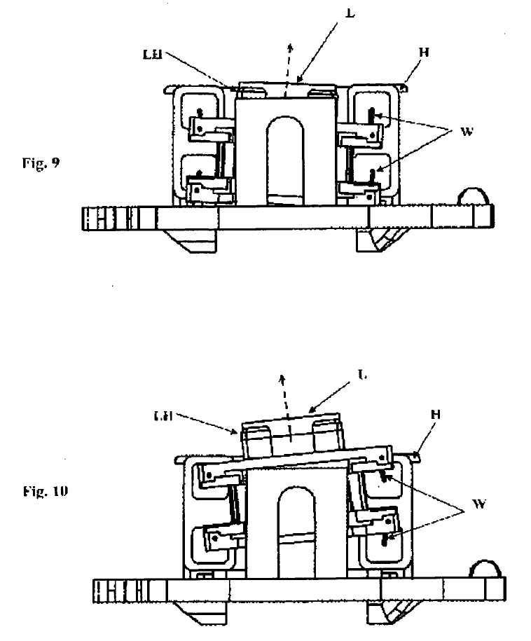

FIG. 9 shows a basic outline of a front view of the optical scanning apparatus with asymmetrical arrangement when the lens is deflected in the focusing direction,

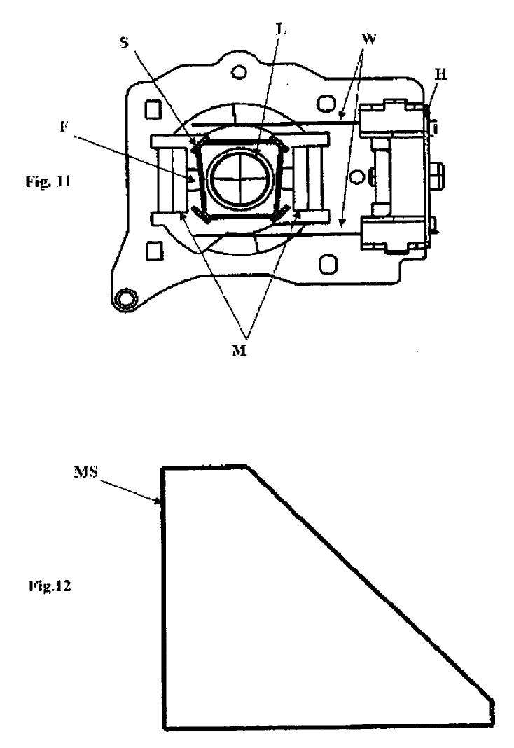

FIG. 10 shows a basic outline of a front view of the optical scanning apparatus with asymmetrical arrangement when the lens is deflected in opposition to the focusing direction,

FIG. 11 shows a basic outline of a plan view of an optical scanning apparatus with a focusing coil of trapezoidal cross-section,

FIG. 12 shows a basic outline of an asymmetrically designed magnet in an optical scanning apparatus,

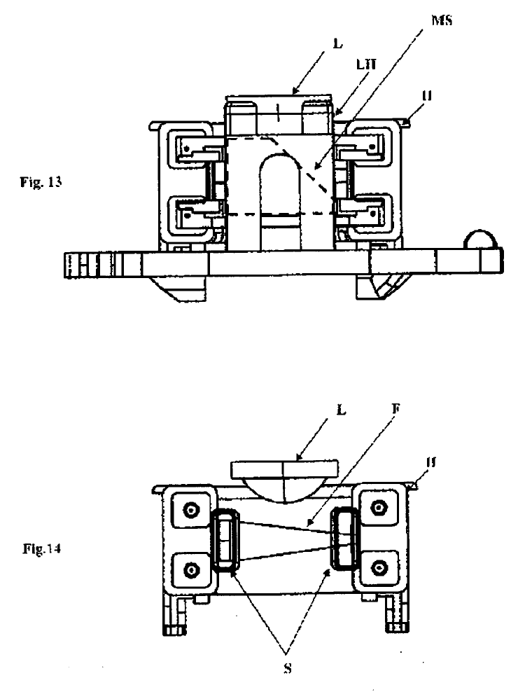

FIG. 13 shows a basic outline of an optical scanning apparatus with an asymmetrically designed magnet,

FIG. 14 shows a basic outline of an optical scanning apparatus with a focusing coil which has a winding arranged in asymmetrically concentrated form,

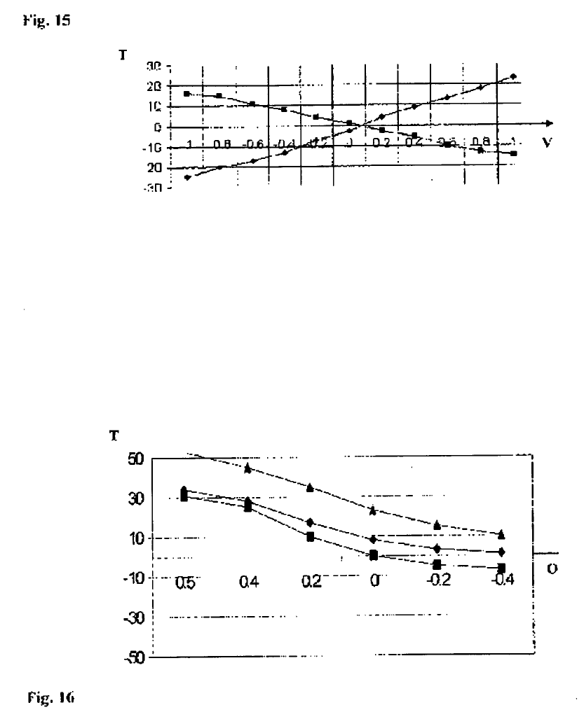

FIG. 15 shows a graph of the angle of inclination of the lens as a function of an asymmetrical arrangement of the magnet for a prescribed deflection of the lens in and in opposition to the focusing direction,

FIG. 16 shows a graph of the angle of inclination of the lens as a function of the deflection of the lens in the focusing direction with an asymmetrical magnet and for different deflections in the radial direction.

Reference symbols are used consistently in the figures. FIG. 1 shows a schematic illustration of a recording medium D with axial runout and uses a dotted line to symbolize the plane of an optimum optical recording medium OPT and a lens holder LH in an optical scanning apparatus with a lens L. Whereas an optimum optical recording medium OPT forms an even area or a plane as an ideal recording medium, a recording medium D with axial runout has discrepancies from this plane predominantly in both directions, and these discrepancies normally increase with the radius R of the recording medium D. The distance between the recording medium D and the plane of the optimum optical recording medium OPT normally increases from the inside to the outside and changes only insignificantly in the case of a recording medium D (also called umbrella disc), as shown in FIG. 2, while the recording medium D is revolving. In the case of a recording medium D with axial runout, on the other hand, the distance normally changes completely from one side to the opposite side after half a revolution. This change—which is dependent on the radius and/or on the axial runout—in the distance from the plane of the optimum optical recording medium OPT results in an inclination—also called tilt T—in the recording medium D which adversely affects or even prevents the recording or reproduction of information with the recording medium D, since only essentially perpendicular scanning allows optimum recording or reproduction. FIGS. 3 and 4 show graphs which illustrate the basic changes in the angle of inclination (called tilt T) as a function of the angle of rotation U and of the radius R of the recording medium D. The graph shown in FIG. 3 shows that the tilt T of an optimum optical recording medium OPT is constantly zero, regardless of an angle of revolution U, and, as illustrated in simplified form by a straight line SD for a recording medium D with axial runout, changes completely from a negative to a positive tilt T or angle of inclination, for example after half a revolution or 180 degrees. FIG. 4 shows the tilt T as a function of the radius R or from the inside of the disc Di to the outside of the disc Do for the optimum optical recording medium OPT and for a recording medium D called an umbrella disc UBD, which has a curvature like an umbrella. The lines deviating from a straight line indicate that the profile of the tilt T in the case of an umbrella disc UBD may also be nonlinear in line with the profile of the curvature, but the basic tendency is for the tilt T to increase with the radius R. To illustrate the direction—left or right from a scanning beam directed perpendicularly onto the optimum optical recording medium OPT—the graphs use a positive and a negative tilt T. The tilt T or angle of inclination is usually given in degrees or minutes, where 1 degree corresponds to 60 minutes.

To ensure that the recording medium D is scanned as perpendicularly as possible despite any curvature or axial runout in the recording medium D, the optical scanning device or the lens L in the optical scanning device is oriented in line with the curvature or the axial runout of the recording medium D, as shown in FIGS. 1 and 2. To record or reproduce information using the recording medium D, the scanning or laser beam directed onto the recording medium D is focused on the information layer of the recording medium D. This is done using a focusing control loop which tracks the lens L or the lens holder LH at a constant distance from the recording medium despite changes in the position. The lens holder LH has a focusing coil F (shown by way of example in FIG. 6) arranged on it which is used to produce a magnetic field which is based on a magnetic field formed by magnets M. This corresponds to the basic design of known optical scanning apparatuses. Known optical scanning apparatuses, as shown in FIGS. 5 and 6, are of essentially symmetrical design in terms of the arrangement of coils and magnets M, in order to deflect the lens holder LH or the lens L from a position of rest to both sides or in both directions as evenly and perpendicularly as possible with respect to one another. The figures show this symmetry using dash-dot lines. For the purpose of tracking, the four corners of the lens holder LH have four winding elements of a tracking coil S which likewise interact with the magnetic field produced by the magnets M. The lens holder LH, which carries the lens L, a focusing coil F and a tracking coil S, is mounted by means of four wires W on a carrier H on which the magnets M are arranged. The four wires W, in addition to being provided for mounting the lens holder LH on the carrier H, are also provided for supplying current to the coils. The arrangement comprising the lens holder LH and the carrier H is called an actuator, which is moved by means of a coarse drive mechanism (not shown) over the data tracks of the optical recording medium D in the radial direction of the recording medium D. The optical scanning apparatus is guided on the information or data track of the disc-like recording medium D using a tracking control loop, which normally comprises a coarse drive mechanism and a fine drive mechanism, where the coarse drive mechanism is a carriage, guided on at least one guide rod, with a toothed rack which is driven by means of an electric motor. The carriage holds the fine drive mechanism, which has a lens holder LH with a lens L, a focusing coil F and at least one tracking coil S. The lens holder LH is connected to the coarse drive mechanism by means of a resilient support comprising relatively thin wires W for supplying current to the coils, and there are magnets M which use the magnetic field from the coils to deflect the lens L from a position of rest. The optical scanning apparatus is guided in a radial direction and at a constant distance for focusing a scanning beam on the information track of the recording medium D in order to record or reproduce information. In order to ensure optimum recording or reading of the recording medium D despite the recording medium D normally being curved toward the edge or having axial runout, a further control loop may be provided which is used to orient the laser beam scanning the recording medium perpendicularly onto the recording medium. To prompt the angle of inclination of the lens L to change at the same time or automatically as the lens L is deflected in the focusing direction of the recording medium D, wires W of different diameter are provided on both sides of the scanning apparatus shown in FIG. 5. The resilient support for the lens L, formed by the wires W, therefore has a different resilience on both sides which results in the lens L being intentionally inclined if there are discrepancies between the recording medium D and an optimum optical recording medium OPT. This known arrangement for producing a “passive tilt” T has the drawback, however, that very narrow tolerances for the wire diameter determining the inclination as a function of the deflection need to be observed during manufacture of the optical scanning apparatus, these tolerances requiring increased complexity, since the tolerance range of wires W which are normally used for the resilient support already exceeds the difference causing the lens L to be inclined to the intended extent. These differences in the wire diameter are normally distributed over the entire length of the roll-wound wires which are used for manufacture, which means that directly adjacent wire sections have far smaller differences and are therefore used advantageously for optical scanning apparatuses without passive tilt T. Since only short, consecutive wire sections are used for manufacturing an optical scanning apparatus, the wire diameter is uniform, which means that the lens L is guided parallel. The different resilience of the elastic support, in a series of manufactured optical scanning apparatuses, influences the use thereof only insignificantly, since a control loop which is provided provides a current or a magnetic field which is required to overcome the opposed force when the lens L is deflected, said force being formed by the elastic or resilient support. To be able to use these advantages of known optical scanning apparatuses without passive tilt T for scanning apparatuses with passive tilt T as well, an optical scanning apparatus is provided which produces the intended tilt T without additional involvement in terms of components and for a wide tolerance range for the wire diameter. This is achieved by virtue of there being an arrangement comprising coils and magnets M which has an asymmetrical magnetic field distribution which is provided in appropriate fashion for matching the orientation of a lens L in the optical scanning apparatus to a curved recording medium D or to any axial runout in the recording medium D. In this case, it was necessary to overcome the prejudice that the asymmetry has a disadvantageous effect on the tracking and the tracking has a disadvantageous effect on the inclination of the lens L in the optical scanning device, since both the tracking coil S and the focusing coil F use the magnetic field from the magnets M. However, it has surprisingly been found that additional deflection of the lens L for tracking influences the tilt T or the intended inclination of the lens L during deflection in the focusing direction only insignificantly or not at all. An intended asymmetrical magnetic field distribution is achieved, in line with the exemplary embodiments below, using different means which can either be used individually or else can advantageously be combined with one another. Thus, in line with a first embodiment, which is shown in FIG. 7, an arrangement of coils and magnets M is provided which has magnets M arranged laterally offset from the position of rest of the lens L or of the focusing coil F. A lateral offset in magnets M which are usually arranged symmetrically with respect to the position of rest of the lens L or of the focusing coil F produces an asymmetrical magnetic field distribution which automatically inclines the lens L upon deflection in the focusing direction. To illustrate the asymmetry, FIGS. 7 and 8 show a dotted line. For better clarity, FIG. 8 shows the focusing coil F and the tracking coil S without the lens holder LH. In addition, the exemplary embodiment shown in FIG. 8 has the tracking coil S arranged in line with the lateral offset of the magnets M, which further reduces the influence of the asymmetrical arrangement on the tracking. The magnets M are arranged offset from the central axis of the lens holder LH in the radial direction of the recording medium D or laterally, which means that the focusing coil F and the tracking coil S are arranged asymmetrically with respect to the magnets M. As a result of this geometric asymmetry, a torque which tilts or inclines the lens holder H and hence also the lens L through a prescribable angle acts during focusing onto the curved recording medium D or the recording medium D with axial runout upon deflection from the position of rest or central position. The principle of the inclination or tilt T in the optical scanning device is shown in FIGS. 9 and 10 in a front view of the optical scanning apparatus when the lens L is deflected in opposition to the focusing direction and when the lens L is deflected in the focusing direction. In the case of an optimum optical recording medium OPT, the lens holder LH with the lens L is in a position of rest, as illustrated in FIG. 13 by way of example. In the position of rest, the lens L is arranged at a distance from the recording medium D at which the scanning beam is focused on the recording medium D. The distance from the recording medium D is kept constant by means of the focusing control loop, so that any curvature in the recording medium D in opposition to the focusing direction or any corresponding axial runout results in lowering as shown in FIG. 9 and, on account of the asymmetrical arrangement of the magnets M with respect to the focusing coil F, simultaneously in automatic inclination of the lens holder LH. When the scanning apparatus is arranged to the right of the central point of the recording medium D and scans the recording medium D on the underside of the recording medium D, the asymmetrical arrangement is chosen such that the lens holder LH is inclined to the right. To illustrate the direction of the scanning beam, FIGS. 9 and 10 show a dashed arrow. In line with the direction of deflection of the lens holder LH, the lens L is inclined to the right or left in order to match the orientation of the lens L to the axial runout or to the curvature of the recording medium D. The dependency of the inclination of the lens L on the lateral offset V of the magnets M with respect to the central axis of the lens holder LH is shown in FIG. 15. FIG. 15 shows the inclination or the tilt T of the lens L in minutes as a function of the lateral offset V in millimetres when the lens L is deflected by 0.5 mm in the focusing direction upwards or downwards. To illustrate associated points on the curves, matching symbols are used. The curves have an approximately linear profile both in the case of deflection in the focusing direction and in the case of deflection in opposition to the focusing direction, and this profile allows simple sizing of the arrangement. FIG. 15 also shows that the lateral offset in the magnets M to the right or left needs to be provided on the basis of the arrangement of the scanning device to the right or left of the central point of the recording medium. The further the magnets M are arranged laterally offset with respect to the central axis of the lens holder LH, the greater the tilt T becomes. The exemplary embodiment shown in FIG. 8 with tracking coils S arranged symmetrically with respect to the laterally offset magnets M has the advantage that the tracking control loop no longer has to correct any asymmetry caused by the arrangement.

FIG. 11 shows a further exemplary embodiment, in which the core cross-section of the focusing coil F is in asymmetrical form. A trapezoidal focusing coil F is provided whose distance from symmetrically arranged magnets M is different. At a shorter distance from a magnetic field source, greater field strength arises, which means that the interaction between focusing coil F and magnet M is greater at a shorter distance and is less at a greater distance. With the asymmetrical magnetic field distribution, the intended tilt T of the lens L is then produced when the lens L is deflected from a position of rest. Tracking coils S and magnets M are arranged symmetrically with respect to the lens L or with respect to the lens holder LH (not shown) in the exemplary embodiment shown in FIG. 11.

In line with a further exemplary embodiment, in contrast to the rectangular magnets M in the other exemplary embodiments, magnets MS are provided which are bevelled on one side. An example of a magnet MS which is bevelled on one side is shown in FIG. 12. The asymmetrical shape of the magnets M, which are arranged symmetrically or asymmetrically relative to the coils, the focusing coil F or the tracking coil S, produces an asymmetrical magnetic field which inclines the lens holder LH during focusing, that is to say during deflection of the lens holder LH. In this way, the lens L is matched to the disc curvature or to the axial runout. The arrangement of the bevelled magnet MS on the carrier H of the lens holder L is shown as a dashed line in FIG. 13, and FIG. 16 uses a graph to show the tilt T of the lens L as a function of the deflection of the lens L in the focusing direction in the case of an asymmetrical magnet or a magnet which is bevelled on one side and for different deflections of the lens L in the radial direction, as required for tracking. The characteristic curves shown in FIG. 16 illustrate the inclination or the tilt T of the lens L as a function of the focus offset voltage O in volts in a position of rest and also upon deflection in the radial direction by plus and minus 0.5 mm. In this case, the central characteristic curve represents the tilt T without lateral deflection of the lens L. The focus offset voltage O is a measure of the deflection of the lens L in the focusing direction or in opposition to the focusing direction in this case. The characteristic curves shown in FIG. 16 show that the tracking has only a minimal influence on the tilt T, despite the bevelled magnet MS. The greater inclination of the lens L can be attributed to the greater influence of the bevel on one side. The offset expected on account of the asymmetry is not a drawback, however, since normally a tilt T of plus/minus 0.25 degrees can be accepted and the offset is minimized further by offsetting the bevel. The particular advantage of this exemplary embodiment is that the lens holder LH is of symmetrical design, which means that no further measures actually need to be provided in principle in order to counteract any displacement of the centre of gravity as a result of coils arranged asymmetrically on the lens holder LH.

FIG. 14 shows a further exemplary embodiment which has a focusing coil F with an unevenly distributed winding. In line with this exemplary embodiment, an asymmetrical magnetic field distribution is achieved with a distribution of the winding on differently shaped winding volumes. Since the shape of the winding determines the magnetic field distribution, the asymmetry results in the lens L being inclined upon deflection in or in opposition to the focusing direction in this case too.

A common feature of the exemplary embodiments is that an arrangement comprising coils and magnets is provided which has an asymmetrical magnetic field distribution which is provided in appropriate fashion for the purpose of matching the orientation of the lens L in the optical scanning device to a curved recording medium D or to any axial runout in the recording medium D. In principle, the cited exemplary embodiments of the asymmetry—whether they be the asymmetrical arrangement of individual components relative to one another or the asymmetrical form of individual components—can be combined with one another. This multiplicity of combination options results in the further advantage that optimum matching to the curvature and to the axial runout of the recording media D for scanning apparatuses of different design is made possible without additional components and without components with a narrow tolerance. As a result of the inclination of the lens L being matched to the curvature or the axial runout of the recording medium D, the error rate when reading information or when writing information on the recording medium is reduced, or the recording or reading of information even becomes possible for the first time, since only perpendicular orientation of the scanning beam onto the recording medium allows optimum reading or writing of information. An optical scanning device for appliances for recording and/or reproducing information on or from recording media is provided which independently or automatically matches itself to the curvature of a curved recording medium D. The scanning apparatus has a lens holder LH with a lens L, a focusing coil F and at least one tracking coil S, said lens holder being mounted by means of a resilient support on a carrier H which holds at least one magnet M for magnetic interaction with the coils and for matching the orientation of the lens L to a curvature or to the axial runout of the recording medium D.

The embodiment described here is indicated merely as an example, and a person skilled in the art is able to implement other embodiments of the invention which remain within the scope of the invention, since several of the exemplary embodiments can be combined and the individual exemplary embodiments can be varied in terms of their sizing.

1. Optical scanning apparatus for appliances for recording or reproducing information using an optical recording medium, said scanning apparatus having a lens holder for holding a lens, a focusing coil and a tracking coil, which lens holder is mounted by means of a resilient support on a carrier which holds at least one magnet for magnetic interaction with the coils, wherein an arrangement comprising focusing coil and magnet is provided which has an asymmetrical magnetic field distribution and wherein a current or the magnetic field of said focusing coil is provided for both to deflect the lens for focusing and to match the orientation of the lens in the optical scanning device to a curved recording medium or to any axial runout in the recording medium.

2. Optical scanning apparatus according to claim 1, wherein a magnet is provided which is arranged laterally offset with respect to a central axis of the lens holder or of the lens when the lens holder is at rest.

3. Optical scanning apparatus according to claim 1, wherein a magnet is provided which is arranged laterally offset in a radial direction of the recording medium from the mid-point of the lens holder or of the lens.

4. Optical scanning apparatus according to claim 1, wherein a focusing coil is provided which is arranged asymmetrically with respect to a magnet.

5. Optical scanning apparatus according to claim 1, wherein the tracking coil is arranged symmetrically with respect to magnets.

6. Optical scanning apparatus according to claim 1, wherein an asymmetrically designed magnet is provided.

7. Optical scanning apparatus according to claim 1, wherein a magnet which is bevelled on one side is provided.

8. Optical scanning apparatus according to claim 1, wherein an asymmetrically designed focusing coil is provided.

9. Optical scanning apparatus according to claim 8, wherein the focusing coil has an asymmetrical core cross-section.

10. Optical scanning apparatus according to claim 8, wherein the focusing coil has an unevenly distributed winding.
